(19) United States
(12) Patent Application Publication
(10) Pub. No.: US 2008/0145506 A1
(43) Pub. Date: Jun. 19, 2008

(54) Food compositions and products containing balanced ratio of essential fatty acids

(75) Inventors: Edward Kane, Millville, NJ (US); Patricia Kane, Millville, NJ (US)

Correspondence Address: LAW OFFICES OF KHALILIAN SIRA, LLC, 9100 PERSIMMON TREE ROAD, POTOMAC, MD, 20854, US

(73) Assignee: BodyBio, Inc., Millville, NJ (US)

(21) Appl. No.: 11/640,574

(22) Filed: Dec. 18, 2006

(51) Int. Cl. A23L 1/24; A23C 9/00; A23D 9/00

(52) U.S. Cl. 426/580; 426/601; 426/605

(57) ABSTRACT

The invention discloses food products and compositions containing a fat content, wherein the fat content has been enriched, supplemented, and/or substituted, partially or totally, with a pre-determined balanced ratio of an omega 6 and an omega 3 essential fatty acid.

### FIELD OF THE INVENTION

This invention relates to food compositions containing essential fatty acids. In particular, the invention relates to food compositions containing a balanced ratio of essential fatty acids.

### BACKGROUND OF THE INVENTION

The general population is more knowledgeable today about their nutritional requirements and the importance of consumption of healthy food products in achieving a superior quality of life than ever before, and the trend is growing. The growing interest in the field of nutrition has led to consumers scrambling for new food products containing fat compositions that were not previously considered to be of critical importance, nor did many suppliers of food products have the incentives to explore these healthier food products. The knowledge of how to produce food products that not only meet the nutritional and health requirements of today while still being delicious and enjoyable has become instrumental in wellness and longevity of the general public. As a result, thousands of health conscious consumers are now desperately seeking alternative foods that are not only delectable but boost their energy and stimulate their immune systems.

The advent of producing low carbohydrate or low fat diets has allowed many classical suppliers of food to produce food products that appeal to weight-conscious consumers. Unfortunately, the majority of these foods have lost their flavor and zest and their nutritional values are under scrutiny by food scientists. The desire to produce high flavor food with increased nutritional value has led food scientists to investigate ways to increase nutritional and medicinal values of traditional culinary products.

U.S. Pat. No. 6,030,650 discloses nutritional dairy-products having a composition containing a variety of vitamins and supplements.

U.S. Pat. No. 6,174,542 discloses chocolate-containing dietary deserts containing a variety of vitamins, mineral and herbal supplements for treating, preventing, alleviating or managing symptoms associated with premenstrual syndrome (PMS) in women.

U.S. Pat. No. 5,869,125 discloses whipped dairy products having low fat compositions wherein at least a portion of the fat is a vegetable oil.

There has been a great emphasis in recent years on food supplemented with a variety of vitamins and/or minerals. Unfortunately, however, the health impacts of the two essential fatty acids, linoleic acid and alpha linolenic acid, have been largely ignored by the food, food supplement, and vitamin companies. As important as the inclusion of vitamins and minerals are in our diet, their effect in maintaining health pales in comparison to the effect of the essential fatty acids, as our health, and even life itself hinges on including these two fats in our daily food.

Essential Fatty Acids (EFAs) are long-chain polyunsaturated fatty acids derived from linolenic, linoleic, and some forms of oleic acids. EFAs are necessary fats that humans cannot synthesize, and must be obtained through diet. EFAs compete with undesirable fats (e.g., trans fats and cholesterol) for metabolism. There are two families of EFAs: omega 3 and omega 6. Omega 9 is necessary yet “non-essential” because the body can manufacture it in a modest amount, provided essential EFAs are present. The number following “omega” represents the position of the first double bond, counting from the terminal methyl group on the molecule. Alpha linolenic acid is an example of omega 3 fatty acids, linoleic acid an example of omega 6 fatty acids and oleic acid an example of an omega 9 fatty acid.

Omega 6 and omega 3 fatty acids have to be in balance in order to provide the body with maximum immune protection. The imbalance of these fatty acids increases the risk for intense and uncontrollable inflammatory responses. For example, an imbalance towards the omega-6 eicosanoids causes white blood cells to release potent immune activating cytokines, which can adversely affect health if chronically or abnormally activated. Likewise, omega 3 fatty acids can dramatically check this process at several levels, including direct inhibition of the eicosanoid producing enzyme cyclooxygenase-2. See, for example, Obata T, et. al., EICOSAPENTAENOIC ACID INHIBITS PROSTAGLANDIN D2 GENERATION BY INHIBITING CYCLO-OXYGENASE-2 IN CULTURED HUMAN NAST CELLS. Clin. Exp. Allergy; 1999, 2:1129-1135).

EFAs support the cardiovascular, reproductive, immune, and nervous systems. The human body needs EFAs to manufacture and repair cell membranes, enabling the cells to obtain optimum nutrition and expel harmful waste products. A primary function of EFAs is the production of prostaglandins, which regulate body functions such as heart rate, blood pressure, blood clotting, fertility, conception, and play a role in immune function by regulating inflammation and encouraging the body to fight infection. Essential Fatty Acids are also needed for proper growth in children, particularly for neural development and maturation of sensory systems, with male children having higher needs than females. Fetuses and breast-fed infants also require an adequate supply of EFAs through the mother's dietary intake. Because high heat destroys linolenic acid, cooking in linolenic-rich oils or eating cooked linolenic-rich fish is unlikely to provide a sufficient amount.

EFA deficiency is common in the United States, particularly Omega 3 deficiency due to the increased use of hydrogenated vegetable oil, and recently, over prescribing and consumption of fish oil. Alpha Linolenic Acid (ALA) is the principal omega 3 fatty acid, which a healthy human will convert into eicosapentaenoic acid (EPA), and later into docosahexaenoic acid (DHA). Omega 3s are used in the formation of cell walls, making them supple and flexible, and improving circulation and oxygen uptake with proper red blood cell flexibility and function. Omega 3 deficiencies are linked to decreased memory and mental abilities, tingling sensation of the nerves, poor vision, increased tendency to form blood clots, diminished immune function, increased triglycerides and “bad” cholesterol (LDL) levels, impaired membrane function, hypertension, irregular heart beat, learning disorders, menopausal discomfort, and growth retardation in infants, children, and pregnant women.

U.S. Pat. No. 5,783,247 describes a process for preparing a flavoring composition suitable as a butter flavor block by subjecting triglyceride fats, fatty acids or fatty acid derivatives containing at least one poly-unsaturated fatty acid with an omega 3 non-conjugatable double bond system to oxidizing conditions.

Compositions containing phospholipids or essential fatty acids and their use in treating central nervous system (CNS) related diseases or disorders have been discovered before. For example, U.S. Pat. No. 6,852,870 discloses the use of omega 3 fatty acids, and omega 3 phoshatidylcholine to treat patients with major depression. Phospholipidic compositions have long been known and used in various ways in nutrition, cosmetics, and pharmaceutical industries. The majority of products containing phospholipids have to be further fluidized by the addition of oil.

U.S. patent application No. 20010033872 discloses compositions containing phospholipids and fatty acids for the treatment or prevention of mental disturbances such as depressive states and for regulating the level of neurotransmitters and thereby improving the function of the central nervous system and cognitive function in humans.

There is a need in the art, therefore, for food compositions that combine multiple mechanisms of action to increase effectiveness of each of the components of the composition and at the same time to contain ingredients having a wide margin of safety, no side effects and immense health benefits. What is desirable then is new food compositions and products containing a balanced ratio of essential fatty acids that not only appeal to the public because of their superior flavor and texture, but also because of their excellent nutritional index. The improvement in the nutritional values of butter, oil, ice cream and other high fat food products is specifically desirable because, historically, many types of these food products have been categorized as high risk food. This invention provides delicious food compositions containing a novel combination of ingredients that have high nutritional values and superior taste.

The invention described herein solves the long felt need by providing novel food compositions and food products utilizing specific food components that are fluidized with a balanced ratio of essential oil composition to restore a healthy balance of essential nutrients paramount to maintaining or restoring the health of the individual.

### SUMMARY OF THE INVENTION

The invention as disclosed herein provides food compositions and products comprising a fat content, wherein the fat content has been enriched, supplemented, and/or substituted, totally or partially, with a pre-determined balanced ratio of omega 6 and omega 3 essential fatty acids.

In one embodiment, the omega 6 and omega 3 fatty acids comprise linoleic acid, and alpha linolenic acid, respectively. The linoleic and alpha linolenic acid are derived from one or more plant or animal sources and can be natural, synthetic, or both.

In another embodiment, the linoleic acid and alpha linolenic acid comprise variants, analogs, derivatives, salts, esters, or chemically modified forms of the linoleic acid and alpha linolenic acid.

In yet another embodiment, the food composition or product contain a pre-determined balanced ratio of the linoleic acid and alpha linolenic acid.

In one embodiment, the balanced ratio of the linoleic acid and alpha linolenic acid is about 4:1, respectively.

In another embodiment, the linoleic acid and alpha linolenic acid are cold pressed, or derived from a blend of organic fatty acids, or both.

In yet another embodiment, the food composition and products additionally contain a source of phospholipid, wherein the phospholipid comprises phosphatidylserine, phosphatidylcholine, phosphatidylethanolamine, phosphatidylglycerol, phosphatidylinositol, phosphatidic acid, cardiolipin, sphingomyelin, ceramide, gangliosides, cerebrosides, or a combination thereof.

The food compositions and products of the invention are used in variety of foods including, for example, dairy compositions (e.g., butter, milk, yogurt, cheese), savory food compositions, sweet food compositions, frozen food, egg products, cooking oil, margarines, spreads, peanut butter, almond butter, sauces, (e.g., mayonnaise, thousand island, tarter) dressings, soups, dips, fillings for cakes and cookies, confections, whipped desserts (e.g., mousse, custard, chiffon, meringue, whipped topping), frozen desserts (e.g., frozen yogurt and ice cream), candies, chocolate bars, baked foods (e.g., cookies, crackers, bread, donut, bagel), and snack bars (e.g. Granola bars), among others.

In one embodiment, the food product of the invention is mayonnaise.

Other preferred embodiments of the invention will be apparent to one of ordinary skill in the art in light of what is known in the art, in light of the following description of the invention, and in light of the claims.

### DETAILED DESCRIPTION OF THE INVENTION

The invention as described herein provides food compositions containing a pre-determined amount of an oil composition containing a balanced ratio of omega 6 and omega 3 essential fatty acids.

As used herein, a “food product” or a “food composition” includes any food product or composition in which its fat content has been enriched, supplement, and/or substituted, totally or partially, with a pre-determined balanced ratio of linoleic acid and alpha linolenic acid essential fatty acids. One or more essential fatty acids are mixed together, or used separately, so long as a pre-determined desired concentration of the linoleic acid and alpha linolenic acid is maintained in the final food product or food composition. The food product and food composition of the invention are totally or partially enriched, supplemented and/or substituted with the essential fatty acid composition.

As used herein, “essential fatty acid composition” refers to one or more compositions comprising linoleic acid and one or more compositions comprising alpha linolenic acid, mixed together in a pre-determined balanced ratio.

As used herein “phospholipids” also referred to as phosphatides and phospholipins, are lipids which contain a phosphoric acid or derivative thereof. Glycerophospholipids, have been referred to as phosphatides and phosphoglycerides, are any glycerophosphoric acid or derivative thereof with one or two acyl, alkenyl or alkyl groups attached to a glycerol residue. These materials may be prepared synthetically or may be derived from natural sources. Natural sources that produce phospholipids are commonly seeds as well as animal products such as eggs.

As used herein, “Omega 3 fatty acids” refer to long chain polyunsaturated molecules beginning with a methyl group and ending with a carboxyl group. Omega-3 fatty acids contain a double bond in the third position from the methyl group. Two common, long chain omega-3 fatty acids are eicosapentanoic acid (20 carbons in length) and docosahexanoic acid (22 carbons in length). These are both found in fish oils.

As used herein, “omega 3 phosphatidylcholine” refers to a triacylglycerol in which the gamma carbon of glycerol is esterified to phosphocholine, and at least one of the other carbons of glycerol is esterified to an omega 3 fatty acid.

The food compositions and food products of the invention are designed on the principle of “balanced nutrients”. The normal body keeps a healthy balance among essential nutrients that is a key in the well being and health of the individual. Certain food composition and food products currently available in the market cause an imbalance in the body of a consumer. The food compositions and products of the invention heal and maintain the health of the subject individual by restoring the balance of essential nutrients to adjust it to a normal level in order to assist the body to fight the abnormal condition and/or ailments and to increase the ability of the immune system to fight disease.

In one embodiment of the invention, the food product or food composition has at least a portion of its normally present fat composition replaced by the essential fatty acid composition of the invention.

Essential fatty acid compositions of the present invention include solutions comprising a mixture of omega 6 and omega 3 fatty acids, in ratio of from about 20/1, 10/1, 5/1, 4/1, 3/1, 2/1, or 1/1. It is intended herein that by recitation of such specified ranges, the ranges recited also include all those specific integer amounts between the recited ranges. For example, in the range of about 4/1, it is intended to also encompass 4.2/1, 3.8/1, 3.5/1, 3.2/1, 3/1, etc, without actually reciting each specific range therewith. Preferably the ratio between the omega 6 and omega 3 fatty acids is about 4/1 v/v.

Alpha Linolenic Acid (ALA) is the principal Omega-3 fatty acid, which a healthy human will convert into eicosapentaenoic acid (EPA), and later into docosahexaenoic acid (DIA). Omega-3s are used in the formation of cell walls, making them supple and flexible, and improving circulation and oxygen uptake with proper red blood cell flexibility and function.

Omega-3 deficiencies are linked to decreased memory and mental abilities, tingling sensation of the nerves, poor vision, increased tendency to form blood clots, diminished immune function, increased triglycerides and “bad” cholesterol (LDL) levels, impaired membrane function, hypertension, irregular heart beat, learning disorders, menopausal discomfort, and growth retardation in infants, children, and pregnant women.

Food containing alpha linolenic acid includes flaxseed oil, flaxseed, flaxseed meal, hempseed oil, hempseed, walnuts, pumpkin seeds, Brazilian nuts, sesame seeds, avocados, some dark leafy green vegetables (e.g., kale, spinach, mustard greens, collards, etc.), canola oil (cold-pressed and unrefined), soybean oil, and others. Higher order omega 3 fatty acids (HUFA) include wild salmon, mackerel, sardines, anchovies, albacore tuna, cod liver oil, fish oil, and other cold water fish. Foods rich in higher order—HUFA omega-3 fatty acids—as wild salmon and sardines are suggested to the subjects as part of their diet.

In one embodiment, one part of alpha linolenic acid as cold pressed, organic flaxseed oil is utilized with four parts of linoleic acid omega-6 oil as cold pressed, organic sunflower oil as a 4:1 omega 6 to omega 3 ratio balanced oil.

Linoleic Acid is the primary Omega-6 fatty acid. A healthy human with good nutrition will convert linoleic acid into gamma linolenic acid (GLA), which will later synthesized with EPA from the Omega-3 group into eicosanoids. Eicosanoids are hormone-like compounds, which aid in many bodily functions including vital organ function and intracellular activity. Some Omega-6s improve diabetic neuropathy, rheumatoid arthritis, PMS, skin disorders (e.g. psoriasis and eczema), inflammation, allergies, autoimmune conditions and aid in cancer treatment.

Food containing linoleic acid includes safflower oil, sunflower seed, sunflower oil, hempseed oil, hempseed, pumpkin seeds, borage oil, evening primrose oil, black currant seed oil, among many others. In one embodiment, evening primrose oil is utilized daily as about 910 mg to about 2600 mg of gamma linolenic acid is contained in this oil.

Long-chain fatty acids serve as precursors of phospholipids in the body and may have independent neurochemical effects as well. Exogenously administered fatty acids are combined within the cell with phosphate moieties donated by ATP molecules to form phospholipids. Omega 3 fatty acids have been linked to the etiology, pathophysiology, and treatment of unipolar major depression. Several lines of evidence support a role for the omega 3 fatty acids in major depression.

Unlike omega 3 fatty acids, omega 6 fatty acids are ubiquitous in developed countries. Omega 6 fatty acids are derived from seed and vegetable oils that have increased in the Western diet through the incorporation of these oils by the food industry and at the recommendation of the American Heart Association and others (Report of the Dietary Guidelines Advisory Committee on the Dietary Guidelines for Americans. In: Dietary Guidelines for Americans; Washington, D.C. US Dept of Health and Human Services; 2000). There is indirect evidence that the optimal dietary ratio of omega-6 to omega-3 fatty acids should be close to 1:1, and under these optimal conditions, the omega-6 fatty acid competes with the omega-3 fatty acid to achieve balanced immune and inflammatory function.

In one embodiment, the invention discloses food products or food compositions containing phosphatidylcholine that have been fluidized with an oil composition containing a pre-determined ratio of omega 6 and omega 3 fatty acids. For example, one or more oil compositions comprising linoleic acid and alpha linolenic acid in an approximately 4:1 (v/v) ratio are used to fluidize a phosphatidylcholine preparation. An example of this type of food product according to the present invention is mayonnaise.

In another embodiment, the essential fatty acid composition of the invention is used to fluidize one or more components of a food composition. For example, for a chocolate-based desert system, the essential fatty acid composition may be used with a granulated sugar component, which can be further fluidized as a vehicle to infuse an additional sweet flavor into the chocolate-based desert system of the present invention. If so, the granulated sugar component may be saturated by a chosen essential fatty acid composition of the invention.

Any commercially available preparation comprising linoleic acid and alpha linolenic acid, or mixtures of the two in an approximately 4:1 (v/v) ratio, can be used as the EFA 4:1 composition in the present methods and food compositions. Suitable EFA 4:1 compositions include the BodyBio Balance 4:1™ EFA oil available from BodyBio Inc. (Millville, N.J. USA), or any mixtures containing the essential fatty acids, such as for example, a mixture of cold pressed organic safflower or sunflower oil and flaxseed oil to yield a 4:1 ratio of linoleic acid to linolenic acid (4 parts Omega 6 to 1 part Omega 3). These fatty acids may be included in the food compositions and food products of the present invention either individually or in mixtures with other fatty acids.

In a preferred embodiment, the essential fatty acids are a blend of organic fatty acids that are cold pressed.

The total amount of the essential fatty acids substituted or supplemented in the food product should be determined in view of the concentration of already existing linoleic acid and alpha linolenic acid in the food product. In one embodiment, the final fat content of the food product has about 10%, 15%, 20%, 30%, 40%, 50% or more of the EFA 4:1. In another embodiment, the amount of the EFA 4:1 is about 60-99% of the final fat content of the food product. If the food product is an oil food product such as, for example, butter, margarine, cooking oil, etc, then the concentration of the EFA 4:1 is about 75% to about 99% or more.

Uptake of a balanced ratio of essential fatty acids omega 6/omega 3 fatty acids such as EFAs 4:1 of the invention increases immune response and manufacture and repair of cell membranes enabling the cells to obtain optimum nutrition and expel harmful waste products. A primary function of EFAs is the production of prostaglandins, which regulate body functions such as heart rate, blood pressure, blood clotting, fertility, conception, and play a role in immune function by regulating inflammation and encouraging the body to fight infection. Essential Fatty Acids are also needed for proper growth in children, particularly for neural development and maturation of sensory systems.

A wide variety of food compositions and products are encompassed within the scope of the invention, so long as their oil composition is totally or partially, substituted, enriched, or supplemented with the balanced essential fatty acid composition of the invention. Food products or food compositions encompassed within the scope of the invention include, by way of example and not limitation, dairy products (e.g., yogurt, sour creme, whipped creme, butter, milk, cheese), cooking oil, margarines, spreads, peanut butter, almond butter, sauces (e.g., mayonnaise, thousand island, tartar sauce, Worchester sauce, Ketchup, etc), dressings, soups, dips for chips, crackers, fillings for cakes and cookies, confections, cake frosting, whipped desserts, frozen desserts, frozen yogurt, whipped topping, bakery glaze, mousse, custard, chiffon, meringue, cappuccino, hard candies, soft candies, granola bars, chocolate bars, cookies, chocolate brownies, cakes, baked foods, ice cream, snack bars, frozen food, bread, and egg products (e.g., scrambled egg), among others.

The ice creams are, for example, low fat ice creams, low carbohydrate ice creams, standard ice creams, premium ice creams, super premium ice creams, or a combination thereof. In one embodiment, the ice cream is a flavored ice cream selected from the group consisting of chocolate, strawberry, vanilla, banana, raspberry, coffee, mocha, pistachio, peach, sesame seed, or a combination thereof.

Also encompassed within the scope of the invention are food compositions or food products additionally supplemented with one or more vitamins, minerals, spice, and and/or herbs. Vitamins include, by way of example, vitamin C, vitamin E, vitamin D, beta-carotene, vitamin K, thiamine, riboflavin, niacin, vitamin B6, folate, vitamin B12, biotin, pantothenic acid, or a combination thereof. Minerals include, by way of example, phosphorus, iodine, magnesium, zinc, selenium, copper, manganese, iron, or a combination thereof. Herbs include, by way of example, St. John's wort, cayenne, ginger, ginseng; herbal extracts, dill weed, parsley, mint, coriander, cumin, tarragon, chives, fenugreek, garlic, onion, or a combination thereof, among others. Spices comprise, by way of example, salt, pepper, lemon & pepper, turmeric, cinnamon, mustard seed, or a combination thereof in a desirable amount, for example, from about one to two table spoons in a 350 ml mixture.

In accordance with one aspect of the present invention, there is provided a snack food product or food composition comprising an egg core rich in posphatidylcholine and an outer butter coating having the EFAs 4:1. The egg core is given sufficient structural integrity to permit battering and breading by the addition of at least one food grade binder, such as for example albumen or gelatin. The egg core may include seasonings, such as salt and pepper, water, citric acid, xanthan gum, skim milk powder, modified starch, flavors, nuts, chocolate, preservatives, color, or a combination thereof among others. Citric acid may be added to stabilize the color of the egg core. Gum and starch may be added to assist in moisture control during freezing and thawing.

In another embodiment, the present invention is directed to a food product or food composition having at least a portion of the normally present triglyceride replaced by the essential fatty acids 4:1 composition of the present invention or an emulsion produced by the processes of the present invention. In the invention the oil or fat-processed food product is a processed food product of a mixture of the above shown oil or fat composition and other food material(s).

The pH of the food product or food composition of the invention can be adjusted with edible vinegar, an organic acid such as citric acid (or a salt thereof), a souring agent such as lemon juice, among others.

The food products and compositions of the invention are used, for example, in preparations such as dressings and mayonnaise with high fat content or compositions of the oil-in-water type, acidic food products, oil, or fat-processed food products. The food products of the invention possess superior flavor and feeling in taste as well as having superior health effects that generally include restoration of cell membrane dysfunction and correction of imbalance and derangement of fatty acids indicative of cell membrane instability.

The food compositions of the invention are formulated into liquid or solid compositions, such as aqueous solutions, aqueous or oily suspensions, syrups or elixirs, emulsions, dispersible powders, granules, and solids among others.

Additionally, the food composition of the invention can contain one or more agents selected from the group consisting of sweetening agents, flavoring agents, coloring agents, antioxidants, and preserving agents in order to provide a commercially palatable preparation. Preservatives included within the scope of the invention are, natural preservatives, or synthetic preservatives such as, for example, ethyl, n-propyl, or p-hydroxy benzoate, among others. Sweetening agents include, for example, sucrose, saccharin, fructose, maltose, glucose, or sodium or calcium cyclamate, among others. Antioxidants include, for example, tocopherol, sodium metabisulphite, butylated hydroxytoluene (BHT), butylated hydroxyanisole (BHA), ascorbic acid or sodium ascorbate, among others.

It will be understood by one of ordinary skill in the relevant arts that other suitable modifications and adaptations to the methods and applications described herein are readily apparent from the description of the invention contained herein in view of information known to the ordinarily skilled artisan, and may be made without departing from the scope of the invention or any embodiment thereof. All references discussed herein are incorporated by reference.

We claim:

1. A food composition comprising a fat content, wherein the fat content has been enriched, supplemented, and/or substituted, totally or partially, with a pre-determined balanced ratio of an omega 6 and an omega 3 essential fatty acid.

2. The food composition of claim 1, wherein the omega 6 and omega 3 fatty acids comprise linoleic acid, and alpha linolenic acid, respectively.

3. The food composition of claim 2, wherein the linoleic and alpha linolenic acid are derived from one or more plant or animal sources.

4. The food composition of claim 2, wherein the linoleic acid and alpha linolenic acid are natural, synthetic, or a combination thereof.

5. The food composition of claim 2, wherein the linoleic acid and alpha linolenic acid comprise variants, analogs, derivatives, salts, esters, or chemically modified forms of the linoleic acid and alpha linolenic acid.

6. The food composition of claim 1, wherein the oil composition comprises a pre-determined balanced ratio of linoleic acid and alpha linolenic acid.

7. The pharmaceutical composition of claim 6, wherein the balanced ratio of the omega 6 and omega 3 essential fatty acid is in a ratio of about 4:1, respectively.

8. The food composition of claim 2, wherein the linoleic acid and alpha linolenic acids are cold pressed, or derived from a blend of organic fatty acids, or both.

9. The food composition of claim 1 additionally containing a source of phospholipid, wherein the phospholipid comprises phosphatidylserine, phosphatidylcholine, phosphatidylethanolamine, phosphatidylglycerol, phosphatidylinositol, phosphatidic acid, cardiolipin, sphingomyelin, ceramide, gangliosides, cerebrosides, or a combination thereof.

10. The food composition of claim 1 comprising dairy compositions, savory food compositions, sweet food compositions, frozen food, egg products, cooking oil, margarines, spreads, peanut butter, almond butter, sauces, dressings, soups, dips, fillings for cakes and cookies, confections, whipped desserts, frozen desserts, candies, chocolate bars, baked foods, and snack bars, or a combination thereof.

11. A food product comprising a fat content, wherein the fat content has been enriched, supplement, and/or substituted, partially or totally, with a balanced ratio of an omega 3 and an omega 6 essential fatty acid.

12. The food product of claim 11, wherein the omega 6 and omega 3 fatty acids comprise linoleic acid, and alpha linolenic acid, respectively.

13. The food product of claim 12, wherein the linoleic and alpha linolenic acid are derived from one or more plant or animal sources.

14. The food product of claim 12, wherein the linoleic acid and alpha linolenic acid are natural, synthetic, or a combination thereof.

15. The food product of claim 12, wherein the linoleic acid and alpha linolenic acid comprise variants, analogs, derivatives, salts, esters, or chemically modified forms of the linoleic acid and alpha linolenic acid.

16. The food product of claim 12, wherein the oil composition comprises a pre-determined balanced ratio of linoleic acid and alpha linolenic acid.

17. The food composition of claim 16, wherein the balanced ratio of the omega 6 and omega 3 essential fatty acid is about 4:1, respectively.

18. The food composition of claim 11, wherein the omega 6 and omega 3 fatty acids are cold pressed, or derived from a blend of organic fatty acids, or both.

19. The food composition of claim 1 additionally containing a source of phospholipid, wherein the phospholipid comprises phosphatidylserine, phosphatidylcholine, phosphatidylethanolamine, phosphatidylglycerol, phosphatidylinositol, phosphatidic acid, cardiolipin, sphingomyelin, ceramide, gangliosides, cerebrosides, or a combination thereof.

20. The food product of claim 11, comprising mayonnaise.
